(19) United States
(12) Patent Application Publication
(10) Pub. No.: US 2015/0285469 A1
(43) Pub. Date: Oct. 8, 2015

(54) LINEAR LIGHTING SYSTEM, MANUFACTURING AND METHODS TO CONFIGURE THE SAME

(71) Applicant: VALERICA GRIGORE, LONGMONT, CO (US)

(72) Inventor: VALERICA GRIGORE, LONGMONT, CO (US)

(21) Appl. No.: 14/672,146

(22) Filed: Mar. 28, 2015

Related U.S. Application Data
(60) Provisional application No. 61/975,234, filed on Apr. 4, 2014.

(51) Int. Cl. F21V 15/01; F21S 8/02; F21V 29/74; F21V 23/00

(52) U.S. Cl. CPC F21V 15/01; F21V 23/009; F21S 8/02; F21V 29/74; F21Y 2103/003

(57) ABSTRACT

Linear lighting fixtures intended to be incorporated into thin architectural surfaces, interconnected and configurable as a continuous run with potential to follow the direction of adjacent planar surface in three dimensional spaces while maintaining the structural integrity of the supporting framework.

### CROSS REFERENCE TO RELATED APPLICATIONS

This application claims priority under 35 U.S.C. §119 to U.S. Provisional Patent Application No. 61/975,234, titled “LINEAR LIGHTING SYSTEM, MANUFACTURING AND METHODS TO CONFIGURE THE SAME”, filed on Apr. 4, 2014.

### BACKGROUND OF INVENTION

The majority of small form factor linear lighting fixtures have their drivers in a remote location due to the fact that there is no room for integral drivers in those types of fixtures. These systems have performance losses caused by their long wires and are more difficult to install than integral driver fixtures.

The remote driver box fixtures are not UL approved for battery packs because most of the battery packs should be factory installed not field installed.

The installer have to drill thru every joist up to the last one near the fixture and route the conduit from the remote driver compartment. This is additional labor and it would considerably increase the overall cost related to this job.

International residential building code prescribes limitations for notching and bored holes in both interior and exterior walls.

The decision about the location of the remote driver compartment is left to the installer and he can run into issues when he is limited by the length of the wire due to limitations imposed by manufacturer for power loss in the wire. He has to take extra steps to add up the segments of the wire way path and figure out the total length. In some situations he has to consult other people like the architect, designer, electrical engineer, building owner, contractors, etc. and incur delays due to these complexities.

For existent construction or remodeling there is a risk to interfere with electrical conduit runs, HVAC ducts or plumbing pipes as these are hidden inside the wall and most initial plans are not available or consulted before the work is started.

Those fixtures with integral driver compartment are designed as to allow driver access and maintenance, from the room side, but they require cutting and reframing structural members that are intended to support the walls and/or ceiling. This could extend or invalidate the building approvals required by the code or other authority therefore extending the overall lead time unnecessary.

Traditional shallow linear recessed fixtures are not usually designed to allow access to replace the light engine while the maintenance of their remote drivers is more difficult than of those fixtures with integral driver.

The warranty for the L.E.D. driver is usually under 5 years while LEDs could have double that lifetime.

The power input of these runs is usually at the end of the fixture. Most of the walls and ceilings would have structural joist members at corner or at the end edges therefore these fixtures are not versatile and are not designed for what is mostly needed: end to end, transition corners, etc.

Most of the other fixtures could not be installed after the planar surface is up, on existent construction. Most of them are for new construction and to be installed before the planar surface is installed.

Various fixtures have been proposed to secure the light sources to the architectural surfaces. Typically, these fixtures have a relatively large depth profile that necessitates excessive clearance space behind the ceiling, wall, or floor surface. In most cases, it may be necessary to reframe a wall to add sufficient depth for the lighting fixture, which may also require cutting and reframing window sills, headers, and other architectural features for structural continuity.

Due to its housing depth and because it's installed to the structure with screws, the integral fixture opening is distorted making the opening variable along the length of the fixture which in turn is not accurate enough to install the light diffusing/converting optical elements like: extruded lens,covers, etc. Additional temporary brackets are used to brace and bridge this opening but they don't eliminate completely the effect and/or they don't control the cause of the distortion (deep housing profile, unknown screw torque force applied by the installed in the field).

### SUMMARY OF THE INVENTION

The use of light as an element of design of architectural surfaces is a distinctive trend in modern times.

In the near future more and more drivers will be integrated into the L.E.D. board. These are so called IC drivers. We can see that trend in direct line AC L.E.D. boards. These boards are connected directly to main power line without the need of a bulky driver to regulate them. Many consumers will want to convert their fixtures by upgrading their L.E.D. boards and this could eliminate one function of the driver compartment as being the enclosure for an L.E.D. driver but the enclosure will still be needed as storage compartment for the additional L.E.D. tape that is a result of using a tape that is not exactly the length of the concatenated run of fixtures. Also, the enclosure will be needed to contain the wire splices, wire nuts or the electrical connectors used to power the L.E.D. tape. This concept is designed to accommodate both, the current need for a driver compartment and the future upgrade. The future L.E.D. light engines could be housed and be powered directly from the power line integral to the small factor channel housing subject to this design.

This linear fixture system is designed to be installed without cutting of the structural joist members and could have any direction along the thin surfaces as well as it can be laid out to create formations of various shapes within these surfaces (for example resembling many if not all the capital letters in the alphabet), geometric figures, etc.

The applications of these fixtures are expanded to architectural accent lighting, general/ambient lighting for both, commercial and residential buildings.

The attached driver compartment option is designed to inherit the advantages of the integral fixtures and remove many of their disadvantages. For example a nearby driver would allow short wires between the L.E.D. board and driver therefore reducing considerably the power efficacy loss. The capability to access and replace a faulty driver is another advantage.

Another reason the traditional fixtures are 3″ to 5″ deep is due to the methods of mixing and diffusing L.E.D. light. The LEDs are oriented directly to the target therefore the point source is visible if it's too close to the lens. Advancements have been done relative to the optics, the diffuser lens are capable to blend the point source into a uniform, glare free, linear source while allowing smaller distances between the diffuser surface and L.E.D. chips.

The light source could be remote phosphor style, traditional white L.E.D. or any other electroluminescent diode that is capable of generating radiation in response to an electrical signal. For example, the light source of a remote phosphor style would comprise of L.E.D.s installed on a printed circuit board (P.C.B.), that would emit blue light, namely a “blue pump” L.E.D, with the dominant wavelength ranging from 450 nm to 460 nm. Above the P.C.B., at a certain distance around the LED, there would be a material that contains phosphor that is intended to convert the wavelength of the photons emitted by the blue pump LEDs to white light spectrum. This phosphor material is separate and not packaged into the L.E.D. therefore it's known as “remote phosphor”.

### BRIEF DESCRIPTION OF THE DRAWINGS

The foregoing and other features and aspects of the invention are best understood with reference to the following description of certain exemplary embodiments, when read in conjunction with the accompanying drawings, wherein:

FIG. 1 illustrates an isometric view, frontal perspective, of a line segment of the embodied lighting system, in accordance with an exemplary embodiment of the present invention;

FIG. 2 illustrates an isometric view, rear perspective, of a line segment of the embodied lighting system, in accordance with an exemplary embodiment of the present invention;

FIG. 3 illustrates a front view of a line segment of the concatenated run of linear fixtures, in accordance with an exemplary embodiment of the present invention;

FIG. 4 illustrates a top view of a line segment of the concatenated run of linear fixtures, in accordance with an exemplary embodiment of the present invention;

FIG. 5 illustrates a back view of a line segment of the concatenated run of linear fixtures, in accordance with an exemplary embodiment of the present invention;

FIG. 6 illustrates section view of a line segment of the concatenated run of linear fixtures taken along section line 6-6 as labeled in FIG. 4, in accordance with an exemplary embodiment of the present invention;

FIG. 7 illustrates section view of a line segment of the concatenated run of linear fixtures taken along section line 7-7 as labeled in FIG. 4, in accordance with an exemplary embodiment of the present invention;

FIG. 8 illustrates a side view of a line segment of the concatenated run of linear fixtures installed in a planar surface, in accordance with an exemplary embodiment of the present invention;

FIG. 9 illustrates an exploded view of a line segment of the concatenated run of linear fixtures installed in a planar surface, in accordance with an exemplary embodiment of the present invention;

FIG. 10 illustrates an exploded isometric view of a line segment of the concatenated run of linear fixtures installed in a planar surface, in accordance with an exemplary embodiment of the present invention;

FIG. 11 illustrates a side view of component 10, named “high voltage wireway channel”, in accordance with an exemplary embodiment of the present invention;

FIG. 12 illustrates a side view of alternate construction of component named “high voltage wireway channel”, in accordance with an exemplary embodiment of the present invention;

FIG. 13 illustrates a side view of corner construction of component named “high voltage wireway channel”, in accordance with an exemplary embodiment of the present invention;

FIG. 14 illustrates a side view of component 20, named “spackle flange”, in accordance with an exemplary embodiment of the present invention;

FIG. 15 illustrates a top view of component 20, named “spackle flange”, in accordance with an exemplary embodiment of the present invention;

FIG. 16 illustrates a side view of light diffusing/converting optical element 30, named “lens”, in accordance with an exemplary embodiment of the present invention;

FIG. 16-A illustrates a side view of a first variation of light diffusing/converting optical element profile named “lens”, in accordance with an exemplary embodiment of the present invention;

FIG. 16-B illustrates a side view of a second variation of light diffusing/converting optical element profile named “lens”, in accordance with an exemplary embodiment of the present invention;

FIG. 17 illustrates a top view of component 40, named “L.E.D. driver enclosure”, in accordance with an exemplary embodiment of the present invention;

FIG. 17-A illustrates a detail/partial view of component 40, taken within the circle “A” as labeled in FIG. 17, in accordance with an exemplary embodiment of the present invention;

FIG. 18 illustrates a section view of component 40, taken along section line 18-18 as labeled in FIG. 17, in accordance with an exemplary embodiment of the present invention;

FIG. 19 illustrates a side view of component 40, named “L.E.D. driver enclosure”, in accordance with an exemplary embodiment of the present invention;

FIG. 20 illustrates an isometric view of component 40 named “L.E.D. driver enclosure”, in accordance with an exemplary embodiment of the present invention;

FIG. 21 illustrates a top view of component 50, named “power input segment housing for light engine”, in accordance with an exemplary embodiment of the present invention;

FIG. 22 illustrates a side view of component 50, named “power input segment housing for light engine”, in accordance with an exemplary embodiment of the present invention;

FIG. 23 illustrates a perspective view of component 50, named “power input segment housing for light engine”, in accordance with an exemplary embodiment of the present invention;

FIG. 24 illustrates an isometric view, frontal perspective, of the internal components of an L.E.D. driver enclosure as installed to frame structure;

FIG. 25 illustrates an isometric view, rear perspective, of the external components attached to the back of an L.E.D. driver enclosure;

FIG. 26 illustrates an exploded view, frontal perspective, of components attached to the front of an L.E.D. driver enclosure;

FIG. 26-A illustrates a detail/partial view taken withing the circle “A”, as labeled in FIG. 26;

FIG. 27 illustrates a perspective view of first components of a line segment of a run of light fixtures installed in a planar surface;

FIG. 27-A illustrates a detail/partial view taken withing the circle “A”, as labeled in FIG. 27, in accordance with an exemplary embodiment of the present invention;

FIG. 28 illustrates a side view of a finished line segment of the concatenated run of linear fixtures installed in a planar surface, in accordance with an exemplary embodiment of the present invention;

FIG. 29 illustrates a top view of the alignment plate 11, in accordance with an exemplary embodiment of the present invention;

FIG. 30 illustrates a top view of the alignment plate 12, in accordance with an exemplary embodiment of the present invention;

FIG. 31 illustrates a top view of an acute corner cleat 13, in accordance with an exemplary embodiment of the present invention;

FIG. 32 illustrates a top view a normal corner cleat 14, in accordance with an exemplary embodiment of the present invention;

FIG. 33 illustrates a top view an obtuse corner cleat 15, in accordance with an exemplary embodiment of the present invention;

FIG. 34 illustrates a perspective view of a bent corner cleat 16, in accordance with an exemplary embodiment of the present invention;

FIG. 35 illustrates a top view of a line segment of the concatenated run of linear fixtures, connected by an alignment plate, in accordance with an exemplary embodiment of the present invention;

FIG. 35-A illustrates a detail/partial view taken withing the circle “A”, as labeled in FIG. 35, in accordance with an exemplary embodiment of the present invention;

FIG. 36-A illustrates an isometric view of a first step process of alignment plate 11 installation, in accordance with an exemplary embodiment of the present invention;

FIG. 36-B illustrates an isometric view of a second step process of alignment plate 11 installation, in accordance with an exemplary embodiment of the present invention;

FIG. 36-C illustrates an isometric view of a third step process of alignment plate 11 installation, in accordance with an exemplary embodiment of the present invention;

FIG. 36-D illustrates an isometric view of a fourth step process of alignment plate 11 installation, in accordance with an exemplary embodiment of the present invention;

FIG. 37 illustrates a front view of a section of line segment row of fixtures installed on a planar surface, in accordance with an exemplary embodiment of the present invention;

FIG. 38 illustrates a section view taken along line segment 38-38, as labeled in FIG. 37, in accordance with an exemplary embodiment of the present invention;

FIG. 39 illustrates a section view taken along line segment 39-39, as labeled in FIG. 37, in accordance with an exemplary embodiment of the present invention;

FIG. 40 illustrates a perspective view of first components of a line segment of a run of light fixtures installed in a planar surface, in accordance with an exemplary embodiment of the present invention;

FIG. 40-A illustrates a detail/partial view taken withing the circle “A”, as labeled in FIG. 40, in accordance with an exemplary embodiment of the present invention;

FIG. 41 illustrates a perspective view of some geometrical figures that could be created on three dimensional planar surfaces utilizing the lighting system in accordance with an exemplary embodiment of the present invention;

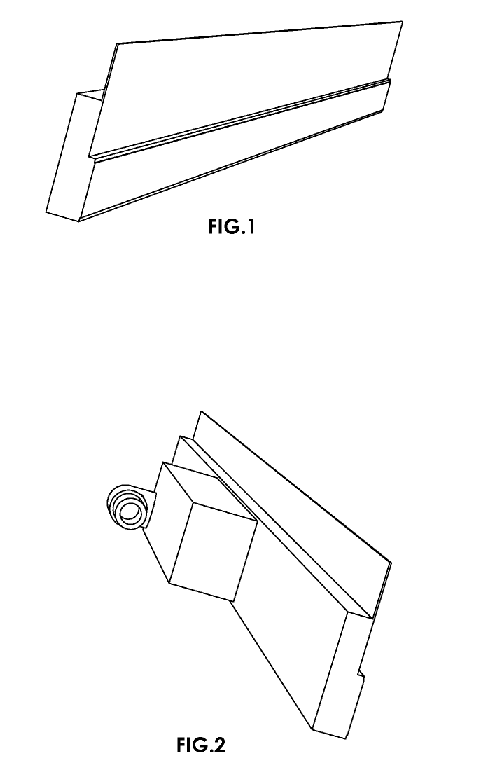

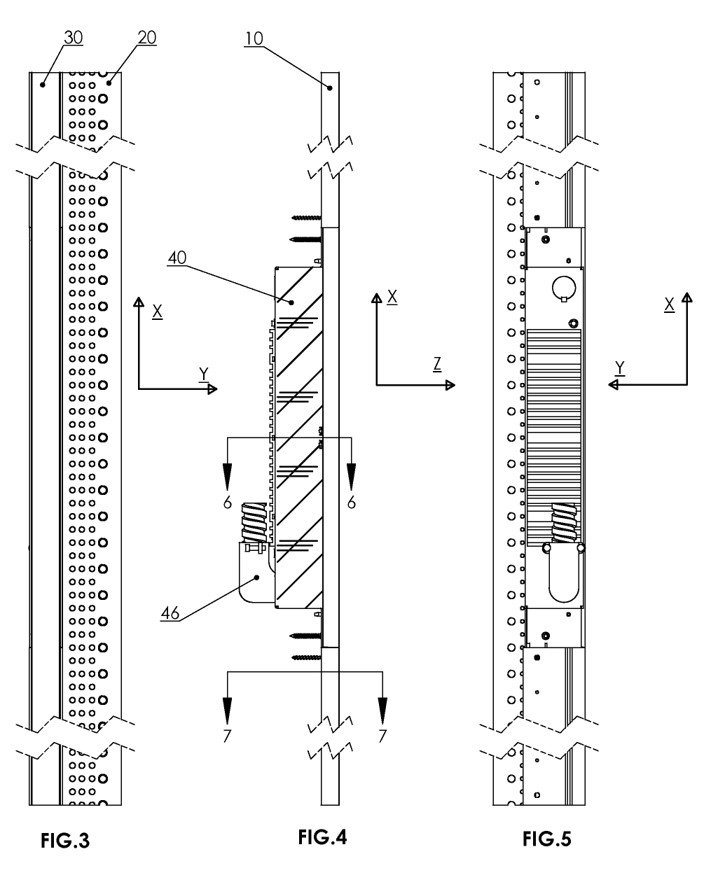

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION OF INVENTION

The present invention is focused on methods to configure linear lighting in different interior building spaces. Although the description of exemplary embodiments is provided below in conjunction with interior building structures, alternate embodiments of the invention are applicable to other illuminated open spaces including, but no limited to, transit, tunnels, staircase, sidewalk, landscape, bollards, parking and other outdoor areas. Furthermore, although the invention has been described with reference to specific methods to configure linear lighting fixtures embedded into interior and exterior architectural surfaces, these descriptions are not meant to be construed in a limiting sense to these applications but a disclosure to apply these concepts to other related applications as recessed lighting applications, cove, surface mount, suspended or track lighting.

Furthermore, although some embodiments of the invention have been described with reference to specific methods to configure linear lighting fixtures, it is within the scope of the invention to apply the same concept to any elongated fixture or to a fixture substantially longer than its width.

In one embodiment, the invention is a linear lighting fixture, intended to be installed on a structure without altering the structural members of its framework comprising: an enclosure, mounted on at least a structural member, wherein said enclosure is sufficiently recessed behind its mounting surface and containing an electrical device used as a power source and control; a channel segment, adjoined to said enclosure and mounted on at least a structural member bearing an opening to access said adjoining enclosure; a channel housing, having an integral wire way chase, abutted to and aligned with said channel segment and mounted on at least a structural member; a covering and anchoring surface, covering said wire way chase; a light source, containing electroluminescent diodes, mounted in said channel, and connected to said electrical device; and, a removable cover, mounted on said channel, wherein said channel would have at least an opening for maintenance access to said power source, after said fixture installation;

In a variation of the embodiment above, the enclosure is placed anywhere along the gap, between the structural members.

In another exemplary embodiment, the invention is a linear light fixture housing comprising: a channel housing, having one or more complementary located flexible locking features; a removable cover, having one or more complementary located flexible locking features; wherein said complementary located flexible locking features engage functioning as a snap-fit cover attachment system for the linear light fixture.

In another exemplary embodiment, the invention is a linear light fixture housing comprising: a channel housing, comprising an outer surface and an inner surface, having at least one indentation integrally formed on its inner surface, in at least one of its side walls; and a removable cover, comprising an outer surface and an inner surface, having at least one complementary indentation integrally formed on its outer surface; wherein said indentation of said channel is for receiving and retaining said complementary indentation of said removable cover and functioning as a snap-fit attachment system of said cover to said channel.

The term “L.E.D.” is known in the art and relates to Light-Emitting Diode: a semiconductor diode that emits light when an electric current passes thru it as a result of a specific voltage applied to its terminals.

The term “L.E.D. driver” is known in the art and relates to an electrical device that manages power and controls the current flow to an L.E.D. lighting source. The electrical device is connected to a power source.

The term “driver enclosure” (abbreviated as D.E.) is related to the L.E.D. driver enclosure, component 40 in our description, and is known in the art as the electrical enclosure housing the L.E.D. driver and constituting a part of the luminaire intended to:
(a) reduce the risk of contact with live parts;
(b) enclose electrical parts and components that can involve a risk of fire;
(c) protect internal parts from mechanical damage; and
(d) protect internal parts from the environment.

The term” opening” should be construed per Underwriters Laboratories (UL) definition as “an aperture in an enclosure that is covered or filled by a plug or knockout and that has the potential of becoming an open hole”.

The term “knockout” (abbreviated as K.O.) relates to a partially cut-out opening that is closed until the precut material is removed. A similar explanation should be related to the term “half-shear” that will be used in our detailed description of the invention embodiment.

The term “heat sink” should be construed as a material of a particular shape intended to absorb excessive heat from a surface and dissipate that heat thru other surfaces.

The term “countersink” should be construed as a conical hole cut into a manufactured object.

The term “plaster” should be construed as “a mixture of lime or gypsum, sand, and water, sometimes with fiber added, that hardens to a smooth solid” and is used for coating walls and ceilings.

The term “spackle” is a trademark referencing a compound used to fill cracks in plaster and produce a smooth surface.

The term “spackle flange” is known in the art as that lighting fixture component that is placed in contact with architectural surfaces for the purpose of applying spackle on top of it and bonding the fixture housing to the architectural surface. Alternatively, in another embodiment, the term “covering and anchoring surface” is largely used in reference to the “spackle flange” component but it's not intended to be limited to that particular embodiment.

The term “elbow connector” is used in piping and electrical fittings to define a change of direction of an electrical conduit at a specific angle (usually 90 degrees).

The term “hinge joint” is used in some embodiments of this invention to define an articulation that would allow motion only in one plane.

For the purpose of this invention, the term “structure” is used in reference to the framework of a building such as an edifice for commercial, residential and industrial space or any other construction establishment.

The term “stud” is known as a building material that is used to construct the frame of that structure.

The term “recessed” is used, in this invention, to define a setback position of a component relative to a planar surface or a mounting surface.

The term “channel” is used to reference an element having an elongated base, a first and a second wall, first wall disposed at a certain distance from the second wall, and extending from the base in a common direction therefore forming a cavity with two open ends.

The abbreviation “H.V.W.C.” meaning “High Voltage Wire Channel” is in reference to component 10 of the lighting fixture segment. Alternatively, in another embodiment, the term “integral wire way chase”, is used in reference to component 10.

The abbreviation “P.I.S./H.-L.E.” meaning “Power Input Segment/Housing for Light Engine” is in reference to component 50 of the lighting fixture segment; Alternatively, in another embodiment, the term “channel segment” is used in reference to component 50, within the scope of the invention, but not limited to that particular embodiment.

In an exemplary embodiment, a fastening method is employed to secure at least two components by interlocking their own features (fastening by shape) or by using intermediate fasteners like screws, clips, clasps, glue, etc.

A “snap-fit” is a mechanical joint system where part-to-part attachment is accomplished with locating and locking features (constraint features) that are homogenous with one or the other of the components being joined. Joining requires the (flexible) locking features to move aside for engagement with the mating part, followed by return of the locking feature toward its original position to accomplish the interference required to latch the components together. “-The First Snap-Fit Handbook”, Bonenberger, 2000 is incorporated herein by reference. Some examples of locking features are: hooks, ridges, grooves, buttons, holes, depressions, indentations, etc.

Descriptions of snap-fit joints can be found in US patent application no. US20070000922 A1 and U.S. Pat. No. 5,102,253 A incorporated herein by reference. Snap-fits joints advantageously eliminate other joining methods, e.g. screws, clips, and adhesives.

For the purpose of this invention, the term “groove” is a long, narrow cut or depression, especially one made to guide motion or receive a corresponding ridge.

For the purpose of this invention, the term “rib” is a long raised piece of stronger or thicker material across a surface or through a structure. For the purpose of defining directionality, a coordinate system needs to be related to a linear segment of the lighting system having a light emitting surface normal to Z axis of a cartezian coordinate system while its length is defined in the X direction and its width in Y direction.

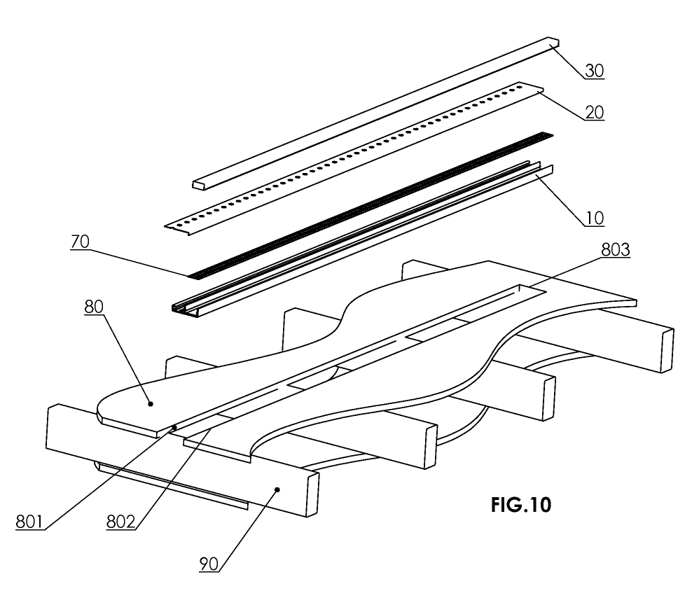

In an exemplary embodiment, depicted in FIG. 10, a planar surface could be a wall 80 that is constructed from one or more drywall sheets arranged on a conventional stud frame. A gap of predefined shape could be created by removing a portion or portions from the one or more drywall sheets. Alternatively, the lighting fixture may first be installed on the studs 90 and the wall may be added later. In other embodiments, the wall may be constructed of wallboard, lathing for plaster, wood, or any other material used to construct an architectural surface.

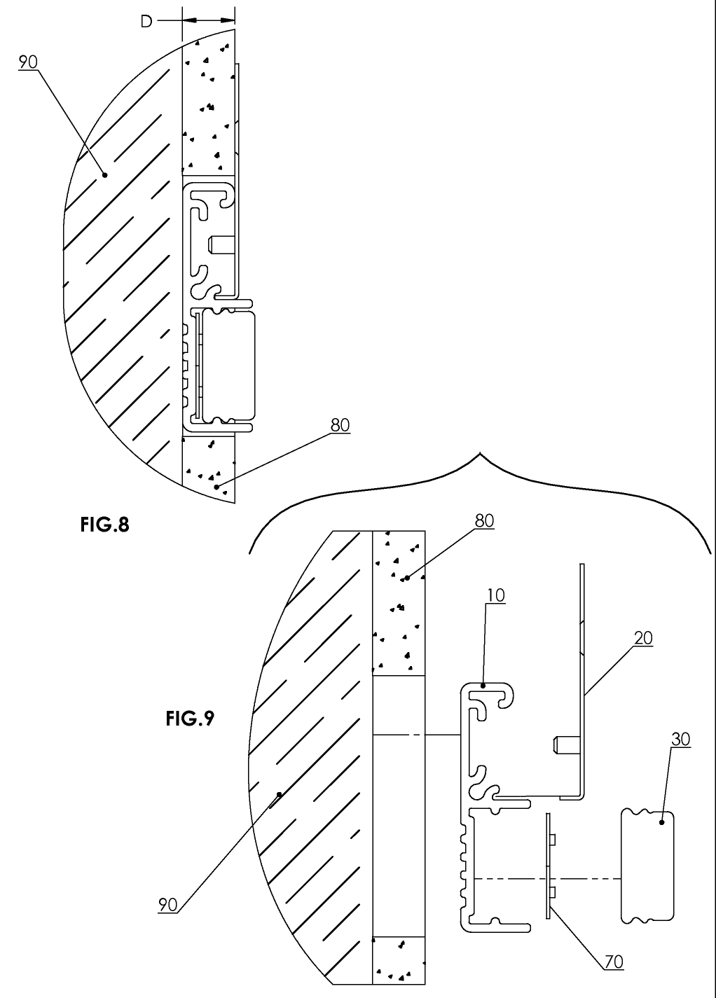

As illustrated by FIG. 10, the basic shape of the gap for a linear segment fixture could have two parallel edges 801 and 802 and it might have an end similar to edge 803. The main components of the slim form factor fixture segment is comprised of: high voltage wire way chase 10 , labeled “H.V.W.C.” , lens 30 and spackle flange 20. A side view of the main components is illustrated by FIG. 8 while FIG. 9 is intended to clarify the profile of these components in an exploded view.

In an exemplary embodiment, a gap of predefined shape might be formed in the planar surface similar to a concatenated sequence of “open” line segments with different angles between them. As seen in FIG. 41, shapes resembling alpabet letters (A,U,C,H,K,L,M,N,T,V,X,Y,Z) could be created on existent architectural surfaces as well as many other geometric figures.

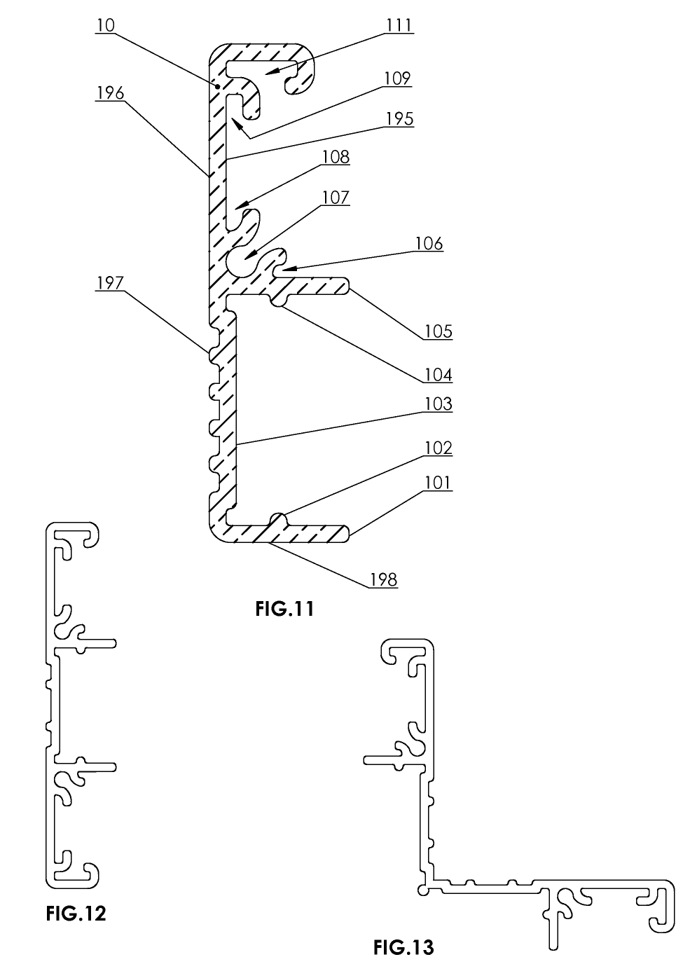

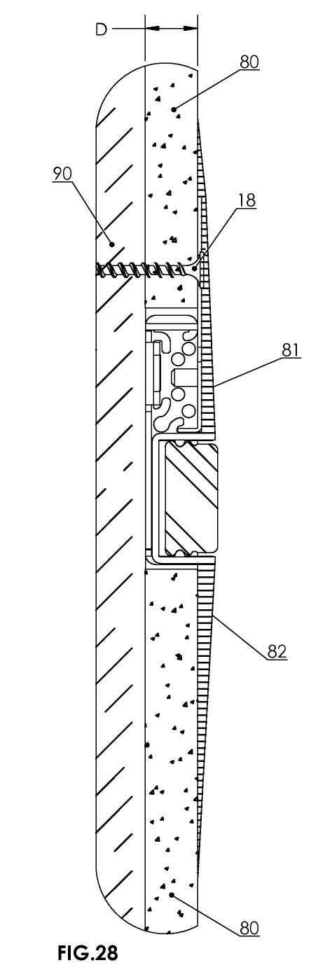

In an exemplary embodiment, as depicted in FIG. 11, an important component of the fixture is the High voltage wireway chase 10 (H.V.W.C.) This component could be an aluminum extrusion that may or may not be painted depending on certain circumstances. Other preferred materials to manufacture this part are the heat conductive materials and/or materials with electrical insulator properties. Some of its features: 101 is a lip intended to be a protective barrier to block particles, like those of the spakle compound 82 or those of the planar surface 80 illustrated in FIG. 28, from reaching the lens 30 or the light source 70 labeled in FIG. 9.

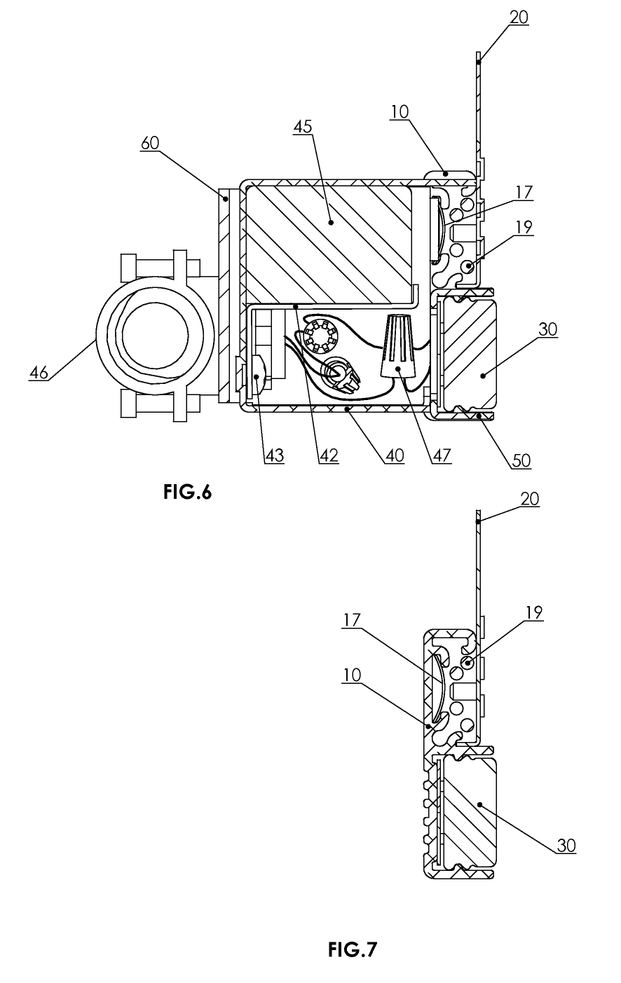

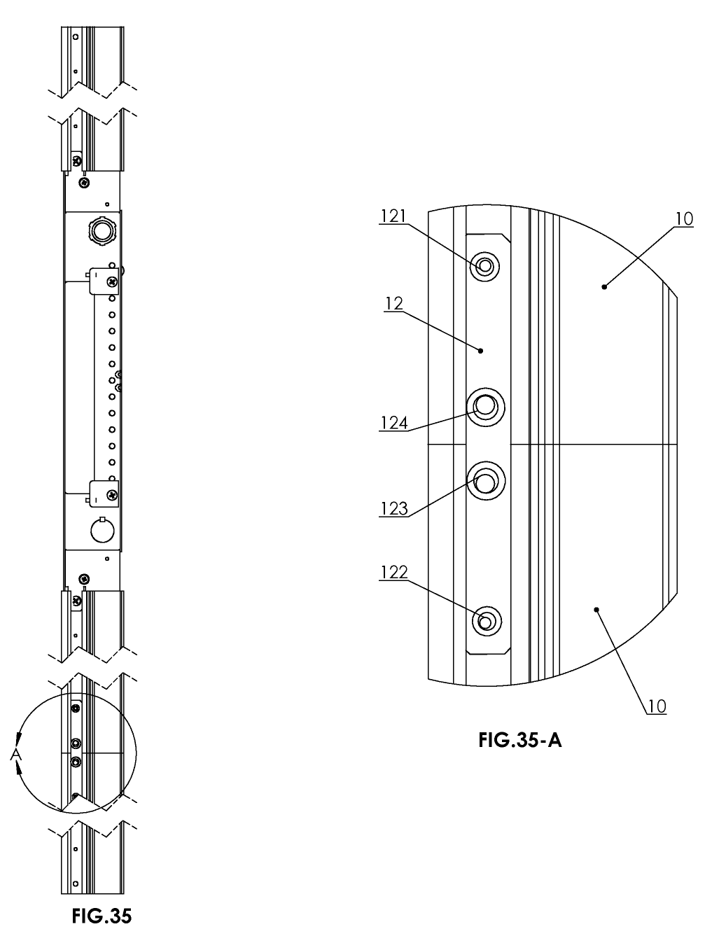

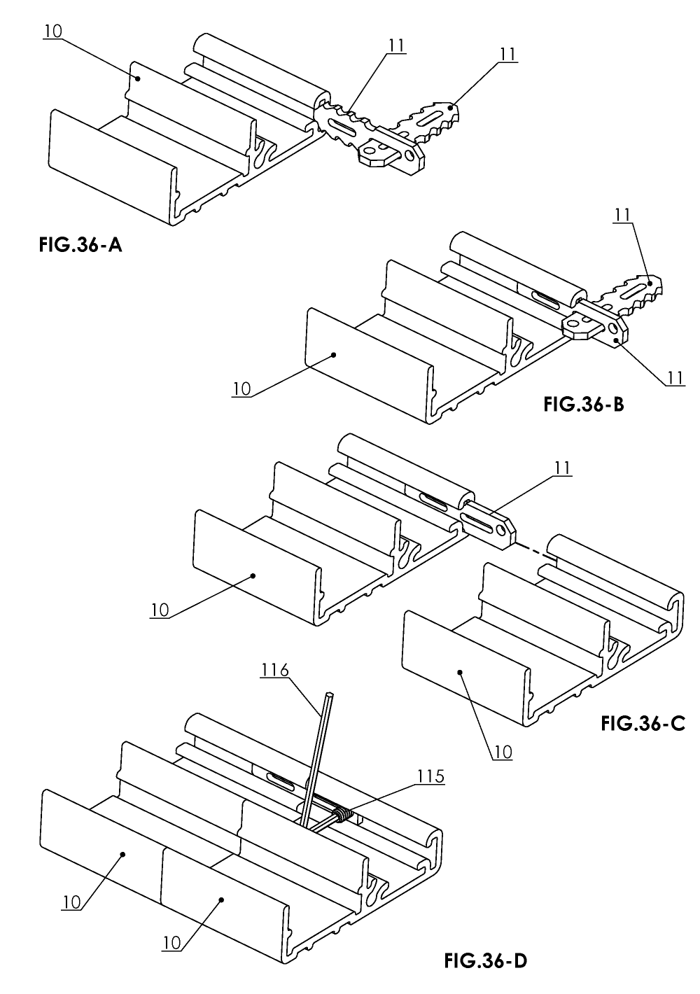

The surface 198 might be an exposed or visible surface, in some configurations, therefore serving as a decorative surface with a required finish. The protrusions 102 and 104 could be one or multiple pairs intended to retain the lens 30 while they are inserted into the channel housing. They are also designed to allow the removal of the lens while a thin object is inserted and acceptable force is applied on that object. The surface 103 is a mounting surface for the L.E.D. light source 70. The feature 105 is a lip intended to be a protective barrier to block particles, like those of the spakle compound 81 of FIG. 28 , from reaching the lens 30 or the light source 70. The top surfaces 105 and 101 are visible from the room side therefore their alignment is important as they have to be perceived as continuous line independent of the number of fixtures that are in the row. The feature 106 is a support receiver channel for the spackle flange 20. The feature 107 is a screw chase feature designed to receive self tapping screws installed from the end. Those screws are used to secure the end caps of the continuous run. Alternatively, this same feature 107 could serve as channel for guide pins between consecutive extrusions. The features 108 and 109 along with 195 could be described as a “T” slot. This is intended as a receiver slot for corner cleats or alignment plates as those depicted in FIG. 30 thru FIG. 34. The “alignment plates” are flat metal plates, mounted between the channel housings and intended to align these channels and to ensure their position is perceived by the majority of the viewers, as a continuous line. The features 108, 109 could also be used to insert protective covers 17 above the screw heads to protect the wires 19 from sharp edges as depicted in FIG. 6 and FIG. 7. The surface 195 is also the surface where the installer would drill holes to secure the fixtures to the structure with wood screws or could have pre-drilled holes to align and pull the extrusions 10 together as seen in FIG. 35-A with the help of self tapping flat head screws installed in 121 and 122 locations and by using aligner plate 12. Next installation step would be directed to the locations 123 and 124 that would receive the wood screws to secure the components to the structure. The feature 111 of FIG. 11 is another “T” slot intended to align the fixtures in a perpendicular direction to the first slot or if additional alignment is required. Corner cleats similar to those depicted in FIGS. 30 thru 34 would be used. The aligners 12, 13, 14, 15, 16, being made of thick steel, could be a guide to drill the holes in the aluminum extrusion especially when the extrusion was “field cut to length” and the holes were removed with the scrap piece.

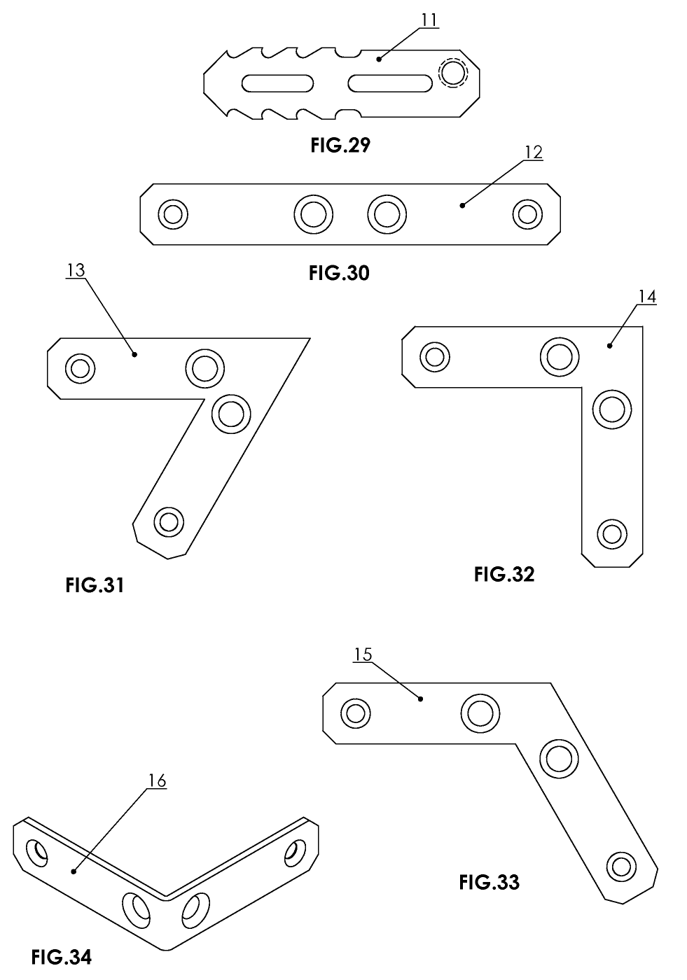

A particular plate for linear alignment is depicted in FIG. 29, namely an aligner plate 11 with a jagged area on its first half and smooth zone on the second half with two slots and a tapped hole. This aligner plate 11 could be inserted into an extrusion 10 as illustrated in FIG. 36-A. A second aligner plate 11 is used temporarily to stop the first aligner plate at a specific depth while its accessible end is tapped with a hammer. When the first plate 11 has reached the intended depth, as depicted in FIG. 36-B, the stop plate is removed and a second extrusion 10 could be inserted in the free end of the aligner plate 11, as illustrated in FIG. 36-C. Once the two extrusions are touching, their contact could be maintained by using a set screw 115 actuated with an Allen wrench 116, as depicted by FIG. 36-D.

As illustrated in FIG. 11, surface 196 is the surface that could be in contact with the structure and could be pierced by holes started from surface 195. The ribs 197 are intended to increase the heat transfer surface on the opposite side of surface 103, where the light engine is installed, and could be considered as heat sink fins. Alternate construction of extrusion 10 is illustrated in FIG. 12, where we can notice 2 symmetric wire way channels. This type of extrusion might be used, for example, when there is a need for 2 circuits that are supposed to be separate. Furthermore, a corner construction for outside longitudinal corner is presented in FIG. 13.

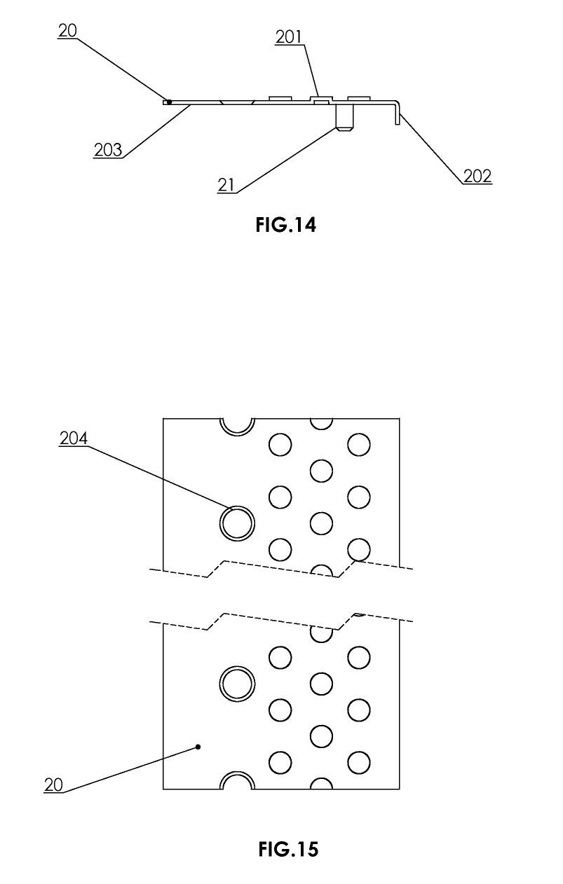

Another component of the lighting fixtures, exemplified in FIG. 14 and FIG. 15, is the spackle flange 20, preferrably made of sheet metal (aluminum, or steel or polimer) but could also be an extruded aluminum component with secondary operations. Grounding screw 21 needs to be factory installed. This could be pre-installed with grounding wire, eyelet, nut and star washer (not shown). The dimples 201 are so called “half-shear” features, well known in sheet metal industry and described previously. They are intended to create the rough surface needed to retain the spackle compound on top of the spackle flange 20.Alternatively, other protruding features could be formed for the above mentioned purpose. The flange 202 has multiple purpose: one is to strengthen the rigidity of a thin sheet metal, when that sheet metal is bent along its surface, and to flatten the remaining surface, the second purpose is to locate the spackle flange relative to the fixture housing. The feature 203 is the surface that is sitting on top of the existent planar surface, like a drywall. The holes 204 are countersink holes intended to reduce the overall height of a flat head screw 18 and allow spackle compond coverage as seen in FIG. 28.

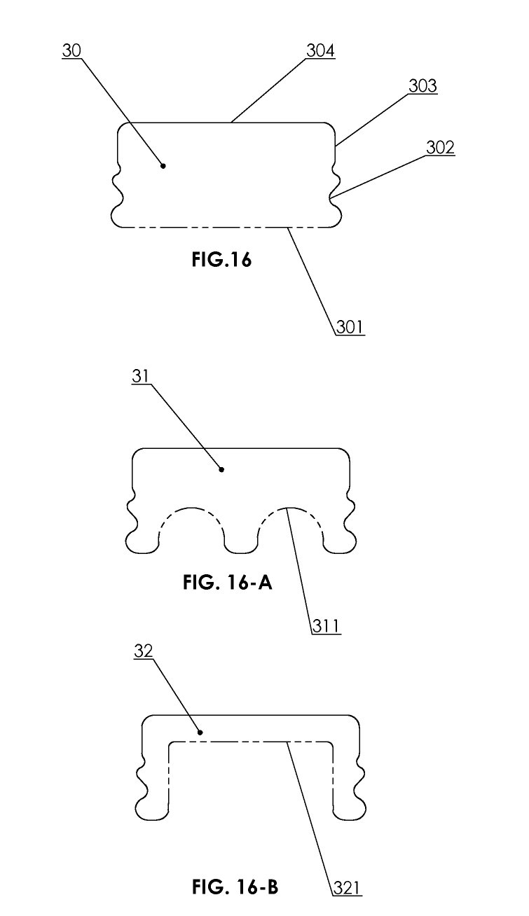

FIG. 16 illustrates component 30, the lens or the light diffusing/converting optical element (internal optical profile not shown). Alternatively, in another embodiment, the term “removable cover” is used in reference to component 30, within the scope of the invention, but not limited to that particular embodiment. The feature 301 is the base of the light diffusing/converting optical element placed near the light source. This surface could have different shapes as exemplified by profile 311 of FIG. 16-A or profile 321 of FIG. 16-B. The feature 302, representing one or more indents on the side of the lens, is intended to retain the lens to the housing but in the same time allow easy snap in of the lens to the housing. In one exemplary embodiment of this invention, the feature 302 of component 30, as depicted by FIG. 16, is defined as “complementary” to feature 102 of component 10, as depicted by FIG. 11, and working as a snap-fit connection, when the two components are put together, as illustrated in FIG. 6, FIG. 7, FIG. 8, FIG. 9 or FIG. 28. Some example of “complementary” located features are groves and ribs or protrusions and indentations. The feature 303 is the surface that would create a sufficient gap beteeen the lens and housing as to allow a thin object to be inserted between the lens and housing for the purpose of lens removal. The surface 304 is the light output surface of the light diffusing/converting optical element. Component 31, as depicted in FIG. 16-A and component 32 of FIG. 16-B are examples of internal profiles of the light diffusing/converting optical elements. The material for these lens or for the removable cover could be made of translucent or transparent plastic materials (i.e. acrylic, polycarbonate, polycarbonate with phosphor) or other light diffusing/converting optical grade materials.

In another embodiment of this invention, the spackle flange 20 and the light diffusing element 30 could be formed as a single piece component.

The light source 70 is primarily comprised of L.E.D. The technology could be blue, white, RGB L.E.D. chips. The circuit could be soft strips, FR boards, OL.E.D.s or any other electroluminescent diode that is capable of generating radiation in response to an electrical signal.

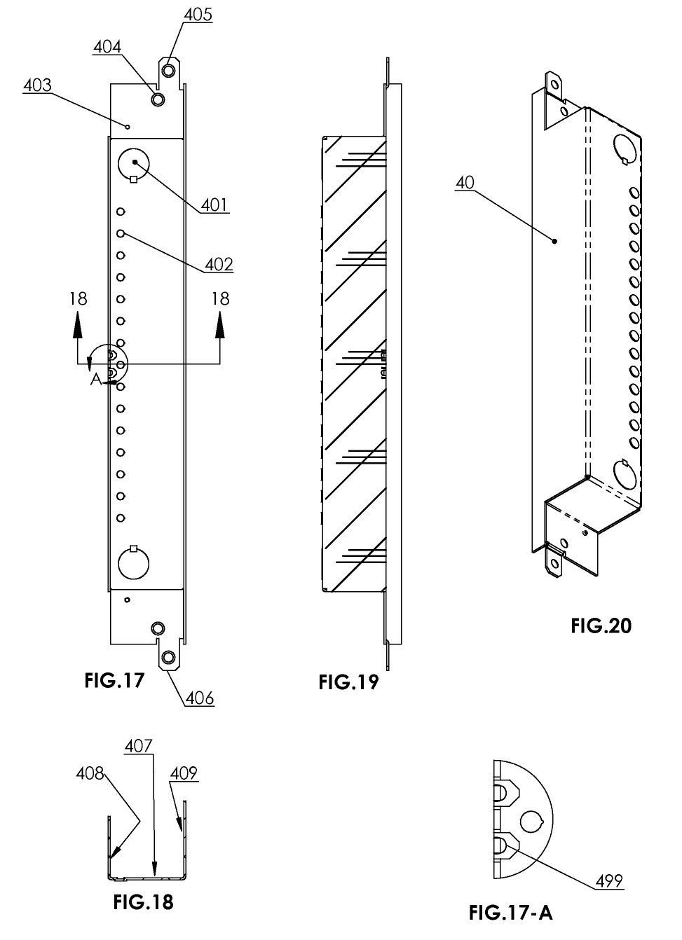

FIGS. 17, 18, 19 and 20 illustrates different view angles of an L.E.D. driver enclosure (D.E.) 40. In FIG. 17, the feature 401 is a knockout intended to be removed if a strain relief device, like an elbow connector 46 depicted in FIG. 4, FIG. 6 or FIG. 25, would need to be installed to the D.E. to provide power or data wires inside the enclosure. The “depth” of the driver enclosure is limited by the size of the structural elements. In an exemplary embodiment of this invention, an enclosure, mounted on a 2″×4″ (2 inches by 4 inches) structural member, is considered “sufficiently recessed”, if its depth, measured from its mounting surface, is less than 4 inches and its protrusions are less than the thickness of the planar surface into which it is installed. The wiring of the L.E.D. driver enclosure (D.E.) could be done thru any opening on the back of the enclosure (“knock out” holes, access hole and cover plate, etc.) There could be one, two or more K.O. that could receive one, two or more elbow connectors, first being to feed the power wires, a second one to feed the control wires (for example the 0-10V wires). The K.O. could be removed by pushing against the round cap from inside with a screw driver or other object having a diameter smaller than the K.O. diameter and being capable to withstand the force necessary to push the round cap until removed. The D.E. could be made of aluminum sheet metal or steel. The elbow could be an off the shelf item usually made of metals (zinc, steel)

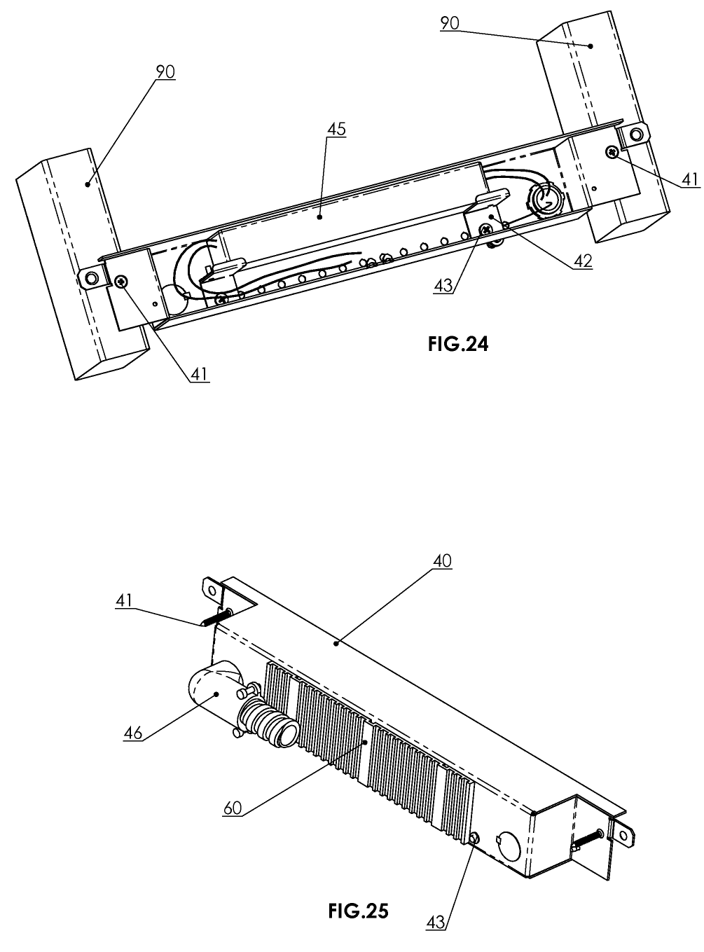

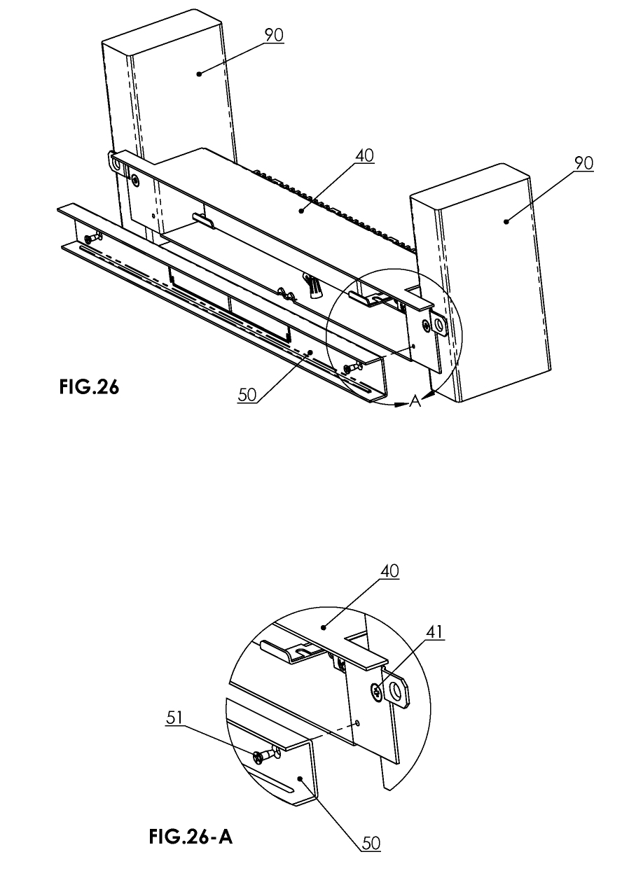

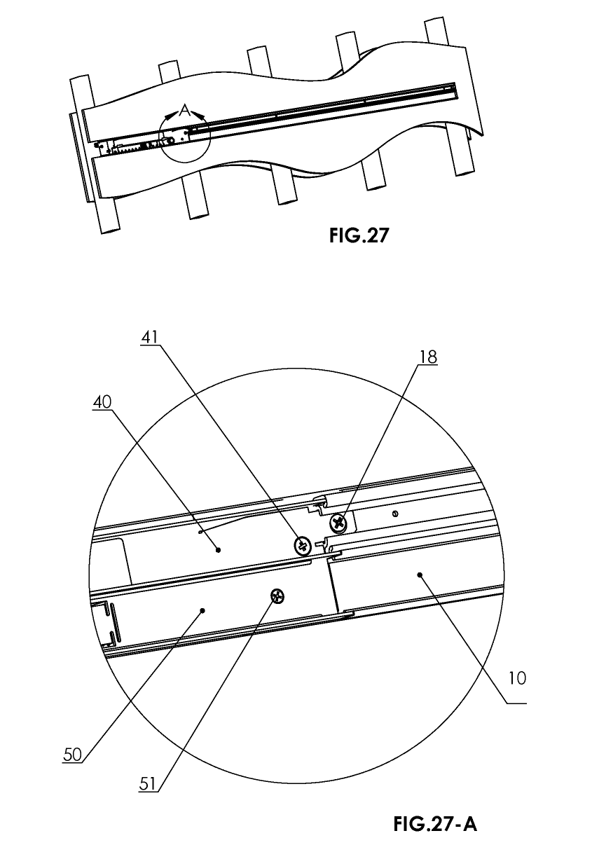

Continuing description of features at FIG. 17, the feature 402 represents an array of half-shear or smaller K.O. features intended for easy removal when a self-tapping screw 43 (FIG. 24) needs to be installed either to mount the L.E.D. driver 45 directly or thru an intermediate bracket 42 to the D.E. 40. The hole 403 is intended to receive a self-tapping screw 51 as depicted in FIG. 26-A. The screw 51 is mounting the P.I.S./H.-L.E 50 to D.E. 40 and ensures bonding of those two components. The hole 404 is a countersink hole, on each side of D.E., intended to receive a flat head wood screw 41 as depicted in FIG. 24 or FIG. 26-A or FIG. 27-A. The screw 41 is securing the D.E. to the structure. In other instances, the 404 hole could be elongated, like a slot. The hole 405 is another countersink hole intended to receive a second flat head wood screw 18 as depicted in FIG. 27-A. The screw 18 is holding together the H.V.W.C. 10 and D.E. 40 to the structure. The tab 406 is a feature, on each side of the D.E. 40, that is intended to ensure alignment of the H.V.W.C. 10 to D.E. 40 as seen in FIG. 27-A. This tab could have another hole, similar to the holes of aligner plate 30, to ensure the H.V.W.C. extrusion 10 is pulled closer to D.E 40. The surface 407 is the back surface of D.E. 40 that could serve as the mounting surface to L.E.D. driver or mounting brackets. Alternatively, 408 or 409 surfaces could be used to support the footprint of the driver or mounting brackets. The tabs 499 are two stops that could be formed from the same piece of D.E. or could be separate piece intended to support the access doors 511 and 510, of component 50, as illustrated by FIG. 23.

On the back of the driver enclosure we can see a set of small mounting K.O. arranged in any appropriate pattern to match the footprint of a series of L.E.D. drivers intended to be installed for every fixture configuration or by using intermediate mounting bracketing. The mounting of the driver depicted in the exemplary embodiment is not intended to restrict the other options that are not shown here as this driver could be installed on the other adjacent surfaces 408 or 409 of the driver enclosure D.E, as seen in FIG. 18.

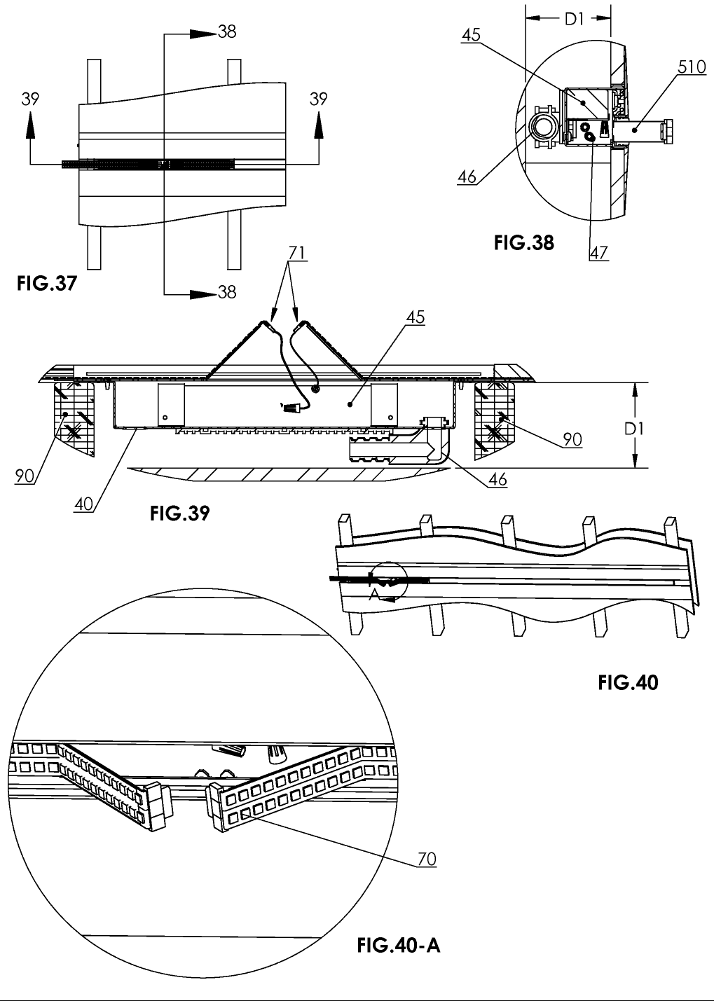

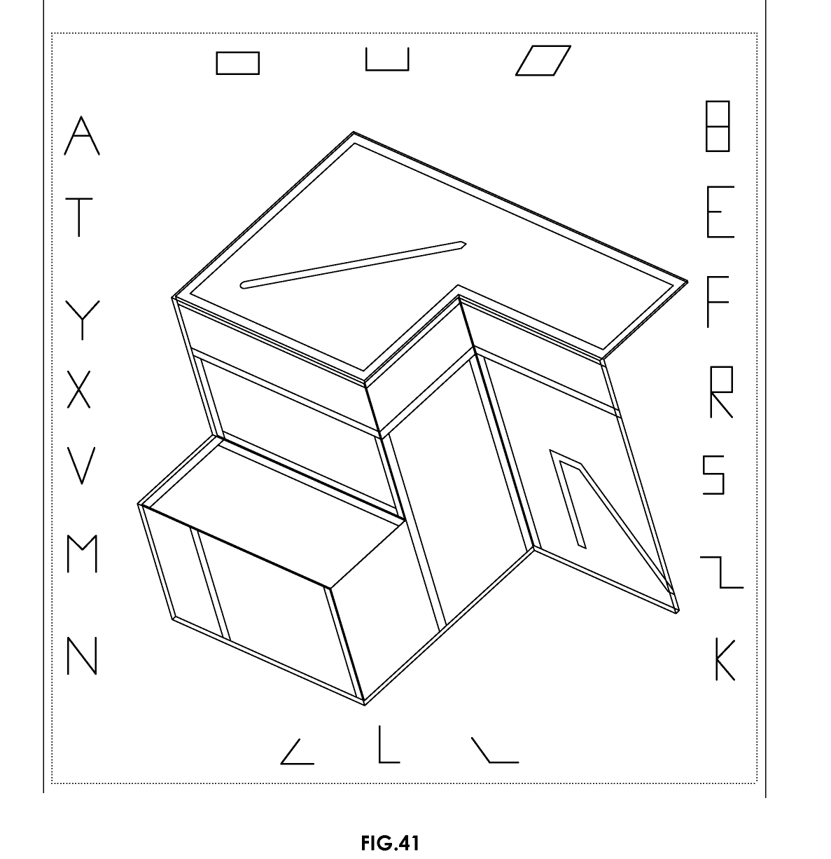

As depicted in FIG. 25, a driver cooling heat sink 60 could be attached to the back of the driver enclosure 40 using the holes pattern on the back of the L.E.D. driver. The heat sink is extruded aluminum with screw channels that could receive screws. FIG. 37, FIG. 38, FIG. 39, FIG. 40 and FIG. 40-A are illustrating D.E. 40 when the access doors 510 and 511 are open for splice inspection. L.E.D. soft strips connectors 71 are depicted in FIG. 39. The enclosure 40 is considered as being “recessed” and, together with the elbow connector 46, intended to fit within the “depth” limitation of that space, labeled “D1”, as depicted in FIG. 38 and FIG. 39. In general, an enclosure is considered “sufficiently recessed” if its depth, measured from its mounting surface, is less than “D1” and its protrusions are equal or less than the thickness of the planar surface “D” plus the thickness of the plaster, if any. The plaster thickness is usually between 1 mm to 6 mm. In general, the materials that are used to manufacture the electrical enclosures and the wire way chase integral to a channel, are: metals (carbon steel, stainless steel, aluminum, etc.), thermoset polyesters (i.e. fiberglass), thermoplastic (i.e. polycarbonate, ABS, etc.), polyesters, fire retardant plastics, etc.

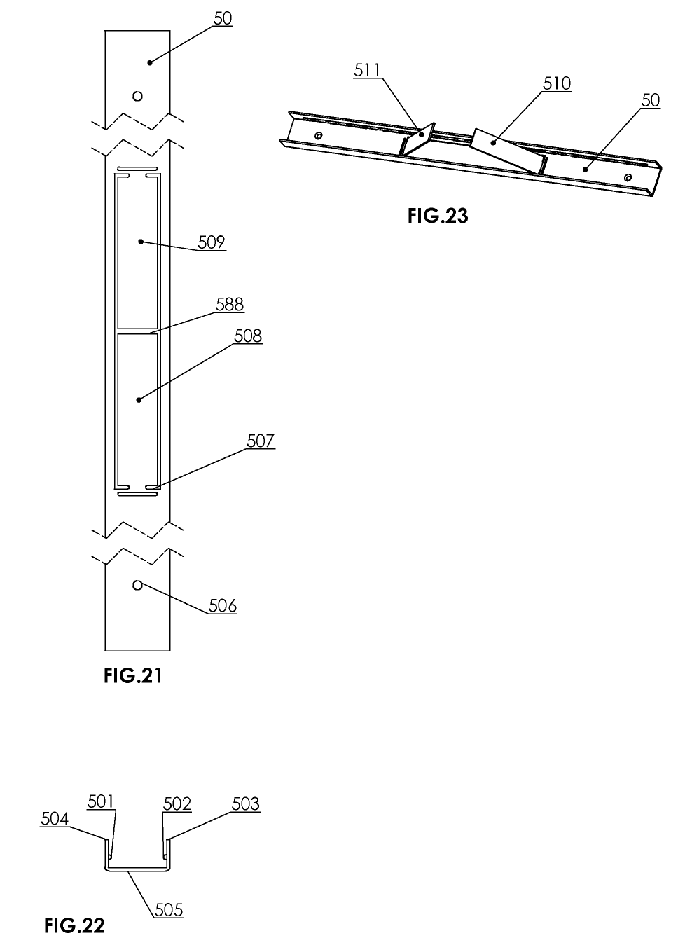

The channel segment or power input segment/housing light engine or P.I.S./H.-L.E labeled 50 as illustrated in FIG. 21, FIG. 22 or FIG. 23, could be made out of sheet metal aluminum or steel. Alternate construction could be made out of extruded aluminum but it would require multiple secondary operations. This segment is intended to match the profile of the extruded H.V.W.C. 10 and ensure row continuity along the lens lines. Also, it needs to allow inspector access, from the room side, to the wire splice compartment. Also, it needs to support the light sources. As illustrated in FIG. 22, the edges 503 and 504 are highly visible and are supposed to match 101 and 105 edges of the H.V.W.C. 10 as presented in FIG. 11 or as it might be depicted in FIG. 6. The dimples 501 and 502 depicted by FIG. 22 are formed and intended to match 102 and 104 depicted by FIG.11. In some instances, when the lens is longer that this segment 50, these dimples might not be needed if there is no visual impact involved. The surface 505 is the mounting surface of 50.The hole 506 illustrates a countersink hole that is intended to receive a self-tapping screw 51, on each side of the housing 50 as depicted in FIG. 26-A. The elements 508 and 509 are hinged access doors that could be manufactured from the same sheet metal piece with the body of 50 or could be separate components. The slots 507 are cut in a specific way as to allow torsion of the remaining bridge material when a regular operator force is applied at the opposite edge 588. As depicted in FIG. 23, 510 and 511 are the two access doors in an open position. As depicted by FIG. 39 and by FIG. 40-A, while the soft strips 70 are installed on the doors 510 and 511, the doors could be opened without removing the strips because the soft strips are flexible light engines. According to UL standard, a luminaire shall allow for inspection of branch circuit connections, after installation. Two minimum size openings, in the electrical enclosure, are supposed to allow passage of a rod having a diameter of ⅝″ (16 mm) and these openings are covered by the access doors, in an exemplary embodiment of this invention.

The envelope of the fixture components installed on the framework that is supporting the architectural surface is defined as having the thickness of the respective surface, labeled “D” as illustated by FIG. 28. In one exemplary embodiment of this invention, the dimension “D” could take values ranging between ¼ inch to 2 inches. The spakle compound 81 and 82 is applied on the planar surface 80 after the installation of a complete row of fixtures and, in some configurations, before the lens 30 and the light source 70 installation. In other configurations, the light engine 70 and the lens 30 could be installed before the spackle compound is applied. Protective tape is recommended to cover the lens if the last option was chosen. This tape should be removed before the fixture is turned on.

A section view thru the driver compartment of the lighting system is presented in FIG. 6. Most of the components description could be found in previous paragraphs except the wire nuts 47 that are used in the industry to make quick connections between solid copper wires.

In summary, these are the functions of the main components, or their features, as described previously:
Spackle flange 20 or covering and anchoring surface
   a) prevent particle intrusion to the integral wire way compartment of the channel housing;
   b) support the spackle/plaster compound;
   c) prevent or reduce plaster cracking;
Electrical enclosure 40
   a) conceal additional L.E.D. tape;
   b) contain the wire splices, mounting brackets, wire nuts and L.E.D. driver;
   c) contain the L.E.D. driver;
Channel/light engine housing 10
   a) prevent dirt particles to reach the reflective surface, the optical surface or the L.E.D. chips;
   b) retain the light diffusing or light converting optical element;
   c) support the L.E.D. light source and transfer the heat out of the light engine;
   d) the integral wire way chase is intended to:
      protect the high voltage wire according to the safety standards;
      contain T-slots intended to ensure alignment of multiple channels by inserting so-called “cleats” between them;
      allow holes to be drilled for mounting to the structure;
      contain screw chase features to ensure end caps mounting;
      support the spackle flange;
power input segment/housing-light engine 50
   a) have an opening for the access doors;
   b) have mounting holes to attach the electrical enclosure;
   c) prevent dirt particles to reach the reflective surface, the optical surface or the L.E.D. chips;
light diffusing or light converting optical element 30
   a) convert blue light to white light;
   b) spread the incident light rays coming from L.E.D. point source to a surface illumination;

In other exemplary embodiment, we define a method of mounting at least one lighting fixture on a structure, without altering the structural members of its framework supporting at least one planar surface, comprising:
a. forming a gap in at least one planar surface;
b. installing at least one electrical enclosure bearing an electrical device attached to a power source, disposed between said structural members, along said gap;
c. mounting at least one channel on said structural members, in the said gap, recessed within the said planar surfaces;
d. attaching at least one covering and anchoring surface to said channel;
e. installing a light source into said channel;
f. connecting said light source to the electrical device; and
g. coupling at least one removable cover to said channel.

Although each exemplary embodiment has been described in detail, it is to be construed that any features and modifications that are applicable to one embodiment are also applicable to the other embodiments. Furthermore, although the invention has been described with reference to specific embodiments, these descriptions are not meant to be construed in a limiting sense. Various modifications of the disclosed embodiments, as well as alternative embodiments of the invention will become apparent to persons of ordinary skill in the art upon reference to the description of the exemplary embodiments. It should be appreciated by those of ordinary skill in the art that the conception and the specific embodiments disclosed may be readily utilized as a basis for modifying or designing other structures or methods for carrying out the same purposes of the invention. It should also be realized by those of ordinary skill in the art that such equivalent constructions do not depart from the spirit and scope of the invention as set forth in the appended claims. It is therefore, contemplated that the claims will cover any such modifications or embodiments that fall within the scope of the invention.

What is claimed is:

1. A linear lighting fixture, intended to be installed on a structure without altering the structural members of its framework, comprising:
an enclosure, mounted on at least one structural member, wherein said enclosure is sufficiently recessed behind its mounting surface and containing an electrical device used as a power source and control;
a channel segment, adjoined to said enclosure and mounted on at least one structural member bearing an opening to access said adjoining enclosure;
a channel housing, having an integral wire way chase, abutted to and aligned with said channel segment and mounted on at least one structural member;
a covering and anchoring surface for said wire way chase;
a light source, containing electroluminescent diodes, mounted in said channel, and connected to said electrical device; and,
a removable cover, mounted on said channel;
wherein said channel would have at least an opening for maintenance access to said power source, after said fixture installation;

2. The lighting fixture of claim 1, wherein said covering and anchoring surface is substantially level with a planar surface and capable of being plastered and painted to match the planar surface into which it is installed;

3. The lighting fixture of claim 1, wherein said removable cover is purposed for diffusion of light or alteration of light wavelength;

4. The lighting fixture of claim 1, wherein said cover is purposed to be removed for the maintenance of said light source;

5. The lighting fixtures of claim 1, wherein said channel segment, could be removed and re-installed, without damaging the surrounding finished surfaces, for maintenance or replacement of said electrical device;

6. The lighting fixture of claim 1, wherein said electrical enclosure would have at least one access door, on the channel side, for wire splice inspection and to conceal the additional L.E.D. tape inside the electrical enclosure;

7. The lighting fixture of claim 1, wherein said opening to access said adjoining enclosure has a hinged joint for opening or a sliding plate enabling easy access to adjoining enclosure;

8. The electrical enclosure of claim 6, wherein at least one access door could be opened while the L.E.D. light source is attached to it;

9. The access door of claim 8, that could be manufactured from the same body of said channel segment, by cutting a perimeter defining its shape and leaving at least a small bridge of material that could be twisted but not cleaved when a regular force is applied by an operator with the intent to open and shut the door;

10. The lighting fixtures of claim 1, that is to be joined with other fixture, by at least one alignment plate;

11. The particular alignment plate of claim 10, that could have a jagged area on its first half, and a smooth zone on the second half, with one slot along each zone and a tapped hole on the smooth zone where the above plate could be press fit in an extrusion channel and travel up to a stop surface created by a second plate temporarily inserted in the slot of the smooth zone of the first alignment plate;

12. The electrical enclosure of claim 6, where at least one tab is formed from the body of said enclosure or at least one stop is attached to the body of the enclosure and is intended to support the access doors while they are shut and to stop them from swinging inside the electrical enclosure;

13. The lighting fixture of claim 1, wherein said channel contains a heat-conducting material;

14. A method of mounting at least one lighting fixture on a structure, without altering the structural members of its framework supporting at least one planar surface, comprising:
a) forming a gap in at least one planar surface;
b) installing at least one electrical enclosure bearing an electrical device attached to a power source, disposed between said structural members, along said gap;
c) mounting at least one channel on said structural members, in the said gap, recessed within the said planar surfaces;
d) attaching at least one covering and anchoring surface to said channel;
e) installing a light source into said channel;
f) connecting said light source to the electrical device; and
g) coupling at least one removable cover to said channel.

15. The lighting fixture arrangement of claim 14, comprising multiple lighting fixtures connected end to end, as a continuous run, and positioned to follow the direction of adjacent planar surfaces in three dimensional spaces while maintaining the structural integrity of the supporting framework.

16. A linear light fixture housing comprising:
a channel housing, having one or more complementary located flexible locking features;
a removable cover, having one or more complementary located flexible locking features;
wherein said complementary located flexible locking features engage functioning as a snap-fit cover attachment system for the linear light fixture.

17. The light fixture housing of claim 16, comprising:
a channel housing, comprising an outer surface and an inner surface, having at least one indentation integrally formed on its inner surface, in at least one of its side walls; and
a removable cover, comprising an outer surface and an inner surface, having at least one complementary indentation integrally formed on its outer surface;
wherein said indentation of said channel is for receiving and retaining said complementary indentation of said removable cover and functioning as a snap-fit attachment system of said cover to said channel.

18. The light fixture housing of claim 16, comprising:
a channel housing, having at least a grooved surface on its inner profile; and
a removable cover, having at least a ribbed surface, on its outer profile;
wherein said grooved surface of said channel is for receiving and retaining said ribbed surface of said removable cover and functioning as a snap-fit attachment system;

19. The light fixture housing of claim 16, wherein said cover can be mechanically coupled, for a snap-fit attachment to said channel, by applying a threshold force on the surface that is external to its shape, until the corresponding flexible locking features of the two components are engaged and locked relative to each other.

20. The light fixture housing of claim 16, wherein said cover can be disengaged and manually removed by applying a threshold force opposite to the force needed to engage the two components.

21. The light fixture housing of claim 16, wherein said removable cover is purposed for diffusion of light or alteration of light wavelength.

22. The light fixture housing of claim 16, wherein said cover is purposed to be removed for the maintenance of said light source.

23. The light fixture housing of claim 16, that is to be joined with other fixture, by at least one alignment plate.

24. The light fixture housing of claim 16, wherein said removable cover would be manually pressed fit and locked inside the channel housing.

25. The light fixture housing of claim 16, wherein said channel contains a heat-conducting material.
